(19) United States
(12) Patent Application Publication
(10) Pub. No.: US 2019/0219076 A1
(43) Pub. Date: Jul. 18, 2019

(54) AN AIRCRAFT SECONDARY CONTROL SYSTEM FOR AIRCRAFT AND A METHOD FOR OPERATING THE SYSTEM

(71) Applicant: SAAB AB, Linköping (SE)

(72) Inventors: Magnus LANDBERG, Linköping (SE); Thomas JERVALL, Linköping (SE)

(73) Assignee: SAAB AB, Linköping (SE)

(21) Appl. No.: 16/303,012

(22) PCT Filed: May 19, 2016
(86) PCT No.: PCT/SE2016/050458

§ 371 Date: Nov. 19, 2018

(51) Int. Cl. F15B 15/26; B64C 13/40; F15B 11/12; F15B 15/14

(52) U.S. Cl. CPC F15B 15/262; F15B 15/148; F15B 11/127; B64C 13/40

(57) ABSTRACT

An aircraft secondary control system comprises a rod arrangement of a driving actuator, configured for performing the motion. The rod arrangement is coupled to the aircraft secondary control member via a linkage arrangement. The driving actuator comprises a first engagement and disengagement device of a piston body and comprises a second engagement and disengagement device, each of which being configured for alternately and/or simultaneously engaging said rod arrangement. The piston body is arranged in a cylinder body and is configured to make a working stroke from a first position to a second position.

### TECHNICAL FIELD

The present invention relates to a method for providing a motion of an aircraft secondary control member incrementally in steps and relates to an aircraft secondary control system for providing said motion.

The present invention furthermore relates to an aircraft comprising an aircraft secondary control system for providing a motion incrementally in steps of an aircraft secondary control member of the aircraft and relates to a data medium storing program adapted for moving an aircraft secondary control member.

The present invention concerns the aircraft industry and especially concerns different systems or applications for controlling secondary control members of an aircraft, such as trailing and leading edge flaps, slots, spoilers, aircraft secondary control members etc. The present invention also concerns the manufacture industry producing such systems.

### BACKGROUND

Aircraft secondary control members are according to some applications configured to be extracted from the wing or fuselage before take-off and landing and are often configured to provide extraction or retraction motion incrementally in steps. The extraction or retraction may be performed in 5 degree increment steps or may also be of other values. The aircraft secondary control members is thus often extracted or retracted in steps or step settings having a small number of degrees, for example three step settings can be used for take-off, such as 8, 11 and 14 degrees and two settings for landing, such as 35 and 46 degrees.

Trailing edge flaps are one type of aircraft secondary control members of high-lift systems increasing the camber of the aircraft wing and increasing the effective wing area when extracted. The trailing edge flaps provide increased take-off performance and permit steeper approach angles and lower landing speeds of the aircraft.

Current aircraft secondary control systems of aircraft may include flap setting optimizing computers for operably election of any one of a plurality of flap step settings, e.g. in providing a motion of the flap from a first extraction step to a second extraction step corresponding to the optimum flap setting responsive to the selection of the designated flap setting of an individual aircraft. Such current system is often complex and involves high costs for operation and maintenance service of the aircraft. Such current system is of high weight as well.

Prior art second control actuating systems of aircraft often comprise bulky power drive units, torque shafts, linear ball screw actuators, gear boxes, other actuators converting rotary input motion to linear output motion and also separate torque brakes being mounted in the wing structure. Current aircraft secondary control systems may involve major drawbacks in that they comprise complex driving actuating systems for driving a linkage arrangement coupled to the aircraft secondary control member. Consequently, current second control actuating systems are heavy, bulky and involve complexity, which implies additional wing structure and weight.

There have been several attempts over a long time for aircraft industry to develop second control actuating systems of aircraft, for overcoming such drawbacks.

U.S. Pat. No. 2,620,147 discloses a secondary control member system for providing an extraction motion incrementally in steps of a flap by means of a hydraulic cylinder. U.S. Pat. No. 2,620,147 discloses a system comprising components controlling the angle of incidence of the flap during its extraction and retraction motion.

U.S. Pat. No. 3,874,617 discloses a rod of a hydraulic actuator, which rod is coupled to a linkage arrangement for controlling the flap. The extension and contraction of the hydraulic actuator moves the linkage arrangement and the aircraft secondary control member between cruise, take-off and landing positions, i.e. provides extraction and retraction motion incrementally in steps.

Current aircraft secondary control member systems may also involve drawbacks in that they do not include any optimized means for providing a motion of the secondary control member from a first extraction step to a second extraction step corresponding to the optimum secondary control member setting responsive to a selection of designated secondary control member settings.

Current aircraft secondary control systems may also involve drawbacks in that they comprise bulky fail-safe locking mechanisms coupled to the system.

### SUMMARY OF THE INVENTION

An object of the present disclosure is to provide an aircraft secondary control system and a method for providing a motion of an aircraft secondary control member incrementally in steps, which seek to mitigate, alleviate, or eliminate one or more of the above-identified deficiencies in the art and disadvantages singly or in any combination.

Yet a further object is to provide a technology step-change for current aircraft secondary control systems.

The above-mentioned object is obtained by a method for providing a motion of an aircraft secondary control member incrementally in steps; wherein a rod arrangement of a driving actuator is configured for performing the motion and is coupled to the aircraft secondary control member; wherein the driving actuator comprises a first engagement and disengagement device of a piston body encompassed in a cylinder body and comprises a second engagement and disengagement device, each of which being configured for alternately and/or simultaneously engaging said rod arrangement; wherein the piston body is arranged in a cylinder body and is configured to perform a working stroke from a first position to a second position; the method comprises the steps of: engaging the first engagement and disengagement device of the piston body to the rod arrangement; controlling the piston body to perform the working stroke to move the rod arrangement a distance corresponding with said working stroke; engaging the second engagement and disengagement device to the rod arrangement; disengaging the first engagement and disengagement device from the rod arrangement; and retracting the piston body from the second position to the first position.

In such way is achieved a compact, cost-effective and light aircraft secondary control system for an aircraft that is configured to make extraction and retraction motions of the aircraft secondary control member incrementally in discrete steps corresponding to recommended aircraft secondary control member settings for proper flight and in accordance with actual aircraft flight manual.

In such way is achieved a less bulky second control actuating system, which in in turn implies a cost-effective manufacture of e.g. an aircraft wing, as its structural components can be designed optimally without any bulky power drive units, torque shafts, linear ball screw actuators, gear boxes, rotary to linear motion converting actuators, separate torque brakes, etc.

In such way the wing design can be simplified compared with current second control actuating systems using electric-driven rotary actuators, since rotating and bending shafts mounted along the wing spar will be excluded.

Preferably, the step of retracting the piston body from the second position to the first position is followed by the steps of; engaging the piston body (by means of the first engagement and disengagement device) to the rod arrangement; disengaging the second engagement and disengagement device from the rod arrangement; moving the piston body together with the rod arrangement a distance corresponding with said working stroke.

Suitably, a first extraction step or a first retraction step of said motion is performed in correspondence with a first movement of the piston body travelling along the length of the working stroke.

Preferably, a second extraction step or a second retraction step of said motion is performed in correspondence with a second movement of the piston body travelling along the length of the working stroke.

Suitably, the working stroke is a full length working stroke made by the piston body within the cylinder body interior.

In such way there is provided extraction and retraction motion of the aircraft secondary control member incrementally in discrete steps, wherein each step corresponds to the piston body full working stroke length.

In such way there is achieved a simple and rigid functionality of the aircraft secondary control system. Each step for extraction and/or retraction of the aircraft secondary control member is well-defined by a single working stroke of the piston body.

Suitably, the rod arrangement is configured move the aircraft secondary control member a first extraction step by said working stroke.

Preferably, the linkage arrangement is configured to provide a first extraction step or first retraction step corresponding with 5 degrees.

Suitably, the linkage arrangement is configured to provide a first extraction step or first retraction step corresponding with 4, 7, 8, 9 or 12 degrees.

Preferably, the rod arrangement of the driving actuator is configured for performing the motion and is coupled to the aircraft secondary control member (alternatively via a linkage arrangement).

The above-mentioned object is also obtained by an aircraft secondary control system configured for providing a motion of an aircraft secondary control member incrementally in steps, the system comprises: a rod arrangement of a driving actuator, configured for performing the motion, is coupled to the aircraft secondary control member (e.g. via a linkage arrangement); the driving actuator comprises a first engagement and disengagement device of a piston body and comprises a second engagement and disengagement device, each of which being configured for alternately and/or simultaneously engaging said rod arrangement; the piston body is arranged in a cylinder body and is configured to make a working stroke from a first position to a second position.

In such way is achieved a well-defined extraction or retraction motion step of the aircraft secondary control member by controlling the piston body, being in engagement with the rod arrangement, to perform a distinct working stroke between the first and second position.

In such way is achieved a space saving aircraft secondary control system.

In such way is achieved low weight of the aircraft secondary control system.

In such way is provided a motion of the aircraft secondary control member in discrete steps.

In such way is achieved a robust and fail safe aircraft secondary control system.

In such way is achieved a aircraft secondary control system for providing an extraction or retraction motion incrementally in steps of an aircraft secondary control member, without any need of power electronics.

Preferably, the linkage arrangement is configured move the aircraft secondary control member a first extraction step or a first retraction step by said working stroke.

Suitably, a fluid supply is coupled via a valve arrangement to the cylinder body and is coupled via the valve arrangement to the first and second engagement and disengagement device.

Suitably, the piston body comprises a radially protruding section, which protrudes outward from the first axially protruding sleeve section, toward a cylindrical inner peripheral surface of a cylinder wall of the cylinder body.

Preferably, the radially protruding section of the piston body divides the cylinder body interior into a first and second cylinder chamber.

Suitably, the first cylinder chamber is coupled by means of a first fluid left to the fluid supply via a first valve member of the valve arrangement.

Preferably, the second cylinder chamber is coupled by means of a second fluid left to the fluid supply via a second valve member of the valve arrangement.

Thereby is achieved that a common fluid supply system can be used for providing the working stroke producing said step and for producing the extraction or retraction stroke of the piston body.

In such way there is required a small fluid reservoir, since the piston body arranged in the cylinder body is configured to make a working stroke from a first position to a second position moving the rod arrangement using a small volume of fluid for providing an extraction or retraction motion step of the aircraft secondary control member.

Preferably, the valve arrangement comprises on/off valves.

Suitably, the valve arrangement comprises leak free poppet valves.

In such way is achieved that certified standard valves can be applied without any need of using servo valves.

Suitably, the valve arrangement and/or the first valve member and/or the second valve member each comprises solenoid on/off valve configured for controlling the flow of fluid to the respective first and second cylinder chamber and to the first and second engagement and disengagement device.

In such way is achieved a cost-effective way to control the operation of the driving actuator for shutting off, releasing, dosing or in other way distributing the fluid to the driving actuator.

In such way being achieved fast and safe switching, high reliability, long service life and compact design of the valve arrangement.

Preferably, the solenoid on/off valve comprises a solenoid and a valve. The solenoid converts electrical energy into mechanical energy which, in turn, opens or closes the valve mechanically.

Suitably, a first solenoid of a first solenoid on/off valve coupled to the first engagement and disengagement device of the piston body is configured in deactivated state to provide an open fluid passage between the fluid supply and a first expandable space of the first engagement and disengagement device.

Preferably, a second solenoid of a second solenoid on/off valve coupled to the second engagement and disengagement device is configured in deactivated state to provide an open fluid passage between the fluid supply and a second expandable space of the second engagement and disengagement device.

In such way is achieved that in case of low current or electrical power cut, the secondary control member is locked in the actual position and does not hazard flight operation.

Suitably, the first engagement and disengagement device comprises a first expandable space configured for fluid communication to a fluid supply.

Preferably, the second engagement and disengagement device comprises a second expandable space configured for fluid communication to a fluid supply.

Suitably, the first engagement and disengagement device is configured to optionally perform a clamping action on the rod arrangement controlled by the valve arrangement.

Preferably, the second engagement and disengagement device is configured to optionally perform a clamping action on the rod arrangement controlled by the valve arrangement.

Suitably, a control unit is coupled to the valve arrangement and to a sensor device of the driving actuator.

Preferably, the method steps are repeated for providing a further motion of the aircraft secondary control member incrementally in steps.

The above-mentioned object is also obtained by an aircraft comprising an aircraft secondary control system for providing a motion of an aircraft secondary control member incrementally in steps, the aircraft secondary control system comprises: a rod arrangement of a driving actuator, configured for performing the motion, is coupled to the aircraft secondary control member (e.g. via a linkage arrangement); the driving actuator comprises a first engagement and disengagement device of a piston body and comprises a second engagement and disengagement device, each of which being configured for alternately and/or simultaneously engaging said rod arrangement; the piston body is arranged in a cylinder body and is configured to make a working stroke from a first position to a second position; wherein the driving actuator is configured for moving the aircraft secondary control member by performing the method steps according to any of claims 1 to 6.

Preferably, the aircraft secondary control system of the aircraft comprises at least one secondary control member at each wing. That is, at least one secondary control member at the right hand wing (right secondary control member) and at least one secondary control member at the left hand wing (left secondary control member).

Suitably, the right secondary control member is coupled to a first rod arrangement of a first driving actuator, configured for performing the motion. The first rod arrangement is coupled to the right secondary control member via a first linkage arrangement. The left secondary control member is coupled to a second rod arrangement of a second driving actuator, configured for performing the motion. The second rod arrangement is coupled to the left secondary control member via a second linkage arrangement.

Preferably, the first driving actuator comprises a first right engagement and disengagement device of a right piston body and comprises a second right engagement and disengagement device, each of the first right engagement and disengagement device and the second right engagement and disengagement device being configured for alternately and/or simultaneously engaging said first rod arrangement. The second driving actuator comprises a first left engagement and disengagement device of a left piston body and comprises a second left engagement and disengagement device, each of the first left engagement and disengagement device and the second left engagement and disengagement device being configured for alternately and/or simultaneously engaging said second rod arrangement.

Suitably, the right piston body is arranged in a right cylinder body and is configured to make a working stroke from a first position to a second position; wherein the first driving actuator is configured for moving the right secondary control member by performing the method steps according to any of claims 1 to 6 related to the right secondary control member. The left piston body is arranged in a left cylinder body and is configured to make a working stroke from a first position to a second position; wherein the second driving actuator is configured for moving the left secondary control member by performing the method steps according to any of claims 1 to 6 related to the left secondary control member.

Preferably, the method comprises the step of instant pressurizing the second right engagement and disengagement device and instant pressurizing the second left engagement and disengagement device at the same time.

Suitably, a right angular potentiometer (sensor) is mounted to the right secondary control member for detecting a first right angular value of the position of the right secondary control member relative the right wing.

Preferably, a left angular potentiometer (sensor) is mounted to the left secondary control member for detecting a first left angular value of the position of the left secondary control member relative the left wing.

Suitably, the left and right angular potentiometers (sensors) are coupled to the control unit.

Preferably, the sensor arranged to the aircraft secondary control member may be a linear potentiometer or any other type of sensor configured to detect the relative values of the respective deflection angle of each aircraft secondary control member of the aircraft.

In such way the aircraft secondary control members of right and left wing can be locked in actual position in case of unlikely discrepancy in extraction or retraction of the control members.

Suitably, a first sensor device is arranged to the first driving actuator and/or to the right secondary control member and/or to the first rod arrangement and is configured for detection of the deflection rate of the right secondary control member (surface).

Preferably, a second sensor device is arranged to the second driving actuator and/or to the left secondary control member and/or to the second rod arrangement and is configured for detection of the deflection rate of the left secondary control member (surface).

Suitably, a control unit of the aircraft comprises a monitoring unit coupled to the first and second sensor devices for monitoring of the deflection position of the right and left secondary control member (surface) respectively.

Preferably, a fluid supply is coupled via a valve arrangement to the second right engagement and disengagement device and to the second left engagement and disengagement device.

Suitably, the control unit is coupled to the valve arrangement for commanding/initiating instant pressurization of the second right engagement and disengagement device and the second left engagement and disengagement device simultaneously (at the same time) in case the monitoring of the deflection rate of the respective right secondary control member and left secondary control member unlikely reveals a difference in deflection position (discrepancy) between the left and right secondary control members.

In such way is achieved a cost-effective and fail-safe way to lock at least two aircraft secondary control members for a fail-safe operation of the aircraft during take-off and landing.

Preferably, the control unit is configured to perform the method steps of; alternately regulating fluid flow from the fluid supply to a respective first and second cylinder chamber of the cylinder body and to the first engagement and disengagement device for moving the rod arrangement; and alternately regulating fluid flow from the fluid supply to the second engagement and disengagement device for holding the rod arrangement.

Preferably, a small accumulator is coupled to a second expandable space of the second engagement and disengagement device via a valve arrangement.

Suitably, a non-return valve is arranged between the accumulator and the fluid supply.

In such way is achieved a cost-effective aircraft secondary control system that can be pressurized in pre-flight check and providing system reliability monitored before flight.

In such way is achieved that the aircraft secondary control system will cope with extremes of demands, such as electrical fluid pump and or EDP (engine driven pump) power cut, and in case of demands for extremely quick respond for temporary pressurizing the second engagement and disengagement device, or variations in fluid temperature.

Suitably, the first engagement and disengagement device comprises a first expandable wall portion arranged adjacent the rod arrangement and is arranged co-axial with the rod arrangement.

Preferably, the first expandable wall portion is arranged to be expandable inward toward the rod arrangement for engagement of the piston body to the rod arrangement.

Suitably, the first expandable wall portion forms a first expandable space of the piston body configured for fluid communication with the fluid supply via a first channel system of the piston body.

Preferably, the first channel system exhibits a first opening facing the first expandable space and exhibits a second opening configured to be in fluid communication with the fluid supply and configured to be coupled to a coupling member positioned exterior the first and second cylinder chamber (exterior the cylinder body).

Preferably, the piston body comprises a first axially protruding sleeve portion protruding from the radially protruding portion, which first axially protruding sleeve portion exposes a first sleeve portion envelope surface (exterior the cylinder body) during said working stroke.

Preferably, the coupling member is arranged at the first sleeve portion envelope surface.

Suitably, the coupling member is arranged in the cylinder wall of the cylinder body.

Suitably, the piston body comprises a first end portion and a second end portion.

Preferably, the first end portion extends through a first opening of a first end cap of the cylinder body.

Suitably, the second end portion extends through a second opening of a second end cap of the cylinder body.

Preferably, the second engagement and disengagement device constitutes a static holding unit comprising a second expandable wall portion arranged adjacent the rod arrangement.

Suitably, the second expandable wall portion is arranged co-axial with the rod arrangement.

Suitably, the second expandable wall portion is arranged to be expandable inward toward the rod arrangement for engagement of the second engagement and disengagement device to the rod arrangement.

Preferably, the second expandable wall portion forms a second expandable space of the second engagement and disengagement device, which second expandable space being configured for fluid communication with the fluid supply via a second channel system of the second engagement and disengagement device.

Suitably, the rod arrangement constitutes a common piston rod which extends through the first and second engagement and disengagement device.

Preferably, the second engagement and disengagement device is fixedly coupled to the piston body and/or fixedly mounted to the aircraft wing structure.

Preferably, the linkage arrangement comprises a first crank member arranged to the aircraft secondary control member.

Suitably, the linkage arrangement comprises a first operating rod member coupled to the first crank member and to a second crank member and/or to the rod arrangement.

Preferably, the second crank member is coupled the rod arrangement.

Suitably, a first extendable and contractible cover is coupled to the first axially protruding sleeve portion and to the cylinder body.

Preferably, a second extendable and contractible cover is coupled to a second axially protruding sleeve portion and to the cylinder body.

Suitably, the extendable and contractible cover comprises a hydraulic fluid drain member arranged for collecting overflow hydraulic fluid leaking from the first cylinder chamber and/or from the second chamber.

In such way is achieved a leakage free aircraft secondary control system.

Preferably, for retraction of the piston body in a retraction stroke from the second position to the first position, the second engagement and disengagement device of a static holding unit holds the rod arrangement and thus locks the aircraft secondary control member.

Suitably, during said holding by the second engagement and disengagement device, the piston body is retracted to the first position for starting position for a new extraction motion in a pre-determined step.

Preferably, the retraction of the piston body to the first position is achieved by pressurization of the first cylinder chamber and is controlled by the control unit by controlling the valve arrangement.

Suitably, the first extraction step may be defined as a first angular displacement of the aircraft secondary control member relative an aircraft wing or an aircraft fuselage.

Preferably, the second extraction step may be defined as a second angular displacement of the aircraft secondary control member relative an aircraft wing or an aircraft fuselage.

Suitably, the piston body and the cylinder body each is symmetrically arranged along a longitudinal axis of the rod arrangement.

Preferably, the cylinder body exhibits a cylindrical inner peripheral surface configured to be mounted around the rod arrangement, a first and a second cap end forming the cylinder body interior.

Preferably, the first axially protruding sleeve portion of the piston body exhibits a larger diameter than a second axially protruding sleeve portion of the piston body.

Suitably, the first end portion comprises an open cavity facing the second engagement and disengagement device and facing away from the first engagement and disengagement device toward the second engagement and disengagement device.

Preferably, the open cavity is dimensioned to encompass the second engagement and disengagement device being positioned along the longitudinal axis and mounted adjacent first end portion.

Suitably, the open cavity is formed to encompass entirely or partially the second engagement and disengagement device during the working stroke of the piston body from the first position to the second position.

Suitably, the piston body comprises a first piston force area having an extension transverse to the longitudinal axis.

Preferably, the first position corresponds with a first end position of the piston body in the cylinder body.

Suitably, the second position corresponds with a second end position of the piston body in the cylinder body.

Suitably, a first and a second piston force area of the radially protruding portion each being determined by a first diameter of the first portion and a second diameter of the second portion, wherein the first diameter is larger than the second diameter.

Preferably, the second piston force area is used for generating a working stroke and the first piston force area is used for generating a retraction stroke. The second piston force area is larger than the first piston force area.

The above-mentioned object is also obtained by a data medium storing program adapted for moving an aircraft secondary control member of an aircraft according to claim 15, wherein said data medium storing program comprises a program code stored on a medium, which is readable on a computer, for causing a control unit to perform the method steps of: engaging the piston body to the rod arrangement; moving the piston body together with the rod arrangement a distance corresponding with said working stroke; engaging the second engagement and disengagement device to the rod arrangement; disengaging the first engagement and disengagement device from the rod arrangement; retracting the piston body from the second position to the first position; repeating the previous steps for providing said motion.

The above-mentioned object is also obtained by a data medium storing program product comprising a program code stored on a medium, which is readable on a computer, for performing the method steps according to any of claims 1 to 6, when a data medium storing program according to claim 16 is run on a control unit.

The expression aircraft secondary control member may mean aircraft secondary control surface.

Preferably, at least two driving actuators may be coupled to one common aircraft secondary control surface, which two driving actuators use one common control system and e.g. one common fluid supply and common valve arrangement.

Suitably, the piston body is configured to perform a working stroke from a first position to a second position, i.e. making a movement from one end of the cylinder body interior to the opposite end of the cylinder body interior.

### BRIEF DESCRIPTION OF THE DRAWINGS

The present invention will now be described by way of examples with references to the accompanying schematic drawings, of which:

FIGS. 1a and 1b illustrate prior art aircraft secondary control systems;

FIG. 1c illustrates an aircraft secondary control system according to a first example of the present invention;

FIGS. 2a to 2d illustrate an aircraft secondary control system according to a second example of the present invention;

FIGS. 3a to 3b illustrate an aircraft secondary control system according to a third and fourth example of the present invention;

FIGS. 4a to 4b illustrate two types of aircraft using the aircraft secondary control system according to further examples of the present invention;

FIG. 5 illustrates an aircraft secondary control system according to a fifth example of the present invention;

FIGS. 6a to 6j illustrate an aircraft secondary control system according to a sixth example of the present invention;

FIG. 7 illustrates a portion of a driving actuator according to a seventh example of the present invention;

FIGS. 8a to 8f illustrate an aircraft secondary control system according to an eight example of the present invention;

FIGS. 9a to 9d illustrate an aircraft secondary control system according to a ninth example of the present invention;

FIGS. 10a to 10d illustrate an aircraft secondary control system according to a tenth example of the present invention;

FIGS. 11a and 11b illustrate alternative flowcharts showing exemplary methods for providing a motion of an aircraft secondary control member incrementally in steps;

FIG. 12 illustrates a control unit of different examples of the invention.

### DETAILED DESCRIPTION

Hereinafter, embodiments of the present invention will be described in detail with reference to the accompanying drawings, wherein for the sake of clarity and understanding of the invention some details of no importance may be deleted from the drawings.

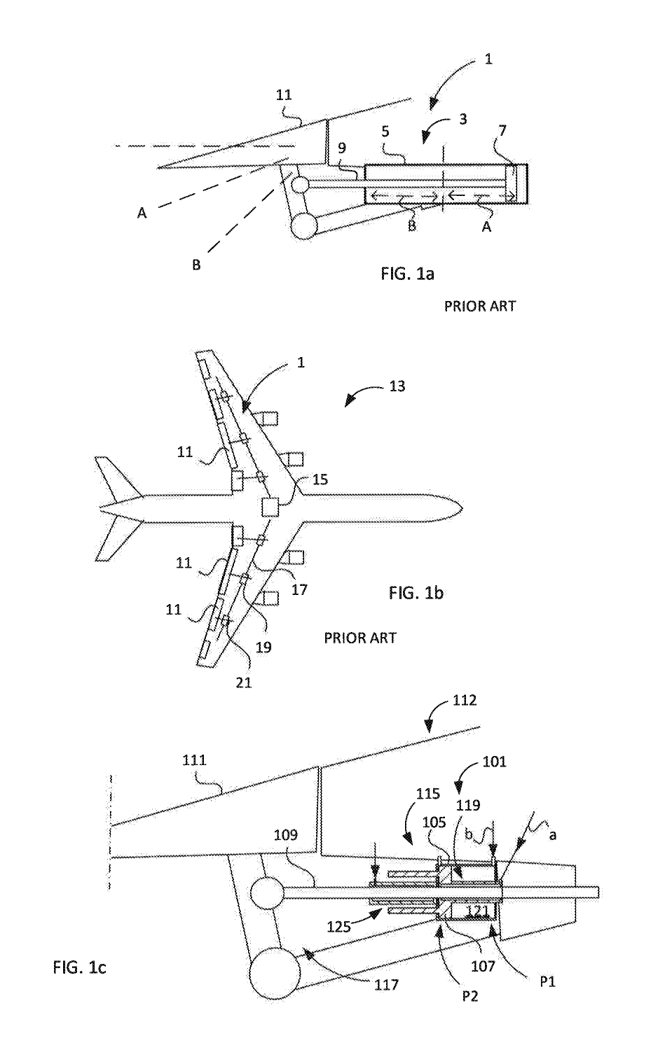

FIGS. 1a and 1b illustrate prior art aircraft secondary control systems 1. FIG. 1a shows a hydraulic actuator 3 comprising a cylinder barrel 5, in which a piston 7 is arranged and connected to a piston rod 9 configured to retract and extract an aircraft secondary control member 11 incrementally in steps A and B. For extraction of step A the piston is moved a distance A. For extraction of step B the piston is moved a distance B. FIG. 1b shows an aircraft 13 comprising an aircraft secondary control system 1 using power drive units 15, torque shafts 17, linear ball screw actuators 19, gear boxes 21 and other actuators converting rotary input motion to linear output motion for moving the aircraft secondary control member 11. The second control actuating system 1 shown in FIG. 1b is heavy, bulky and involves complexity, which implies additional wing structure and weight.

The extraction of the aircraft secondary control member 11 in step A, involves an angular displacement of the aircraft secondary control member 11 in 10 degrees. Step A may involve also other angular displacements of the aircraft secondary control member 11 for other embodiments.

FIG. 1c illustrates an aircraft secondary control system 101 according to a first example of the present invention. The aircraft secondary control system 101 is configured to provide a motion of an aircraft secondary control member 111 of an aircraft wing 112 incrementally in steps. The aircraft secondary control system 101 comprises a rod arrangement 109 of a driving actuator 115. The driving actuator 115 is configured for performing said motion. The rod arrangement 109 is coupled to the aircraft secondary control member 111 via a linkage arrangement 117. The driving actuator 115 comprises a first engagement and disengagement device 119 of a piston body 107. The piston body 107 is arranged in a cylinder body 105 and is configured to make a working stroke from a first position P1 to a second position P2. The first engagement and disengagement device 119 is configured to engage the rod arrangement 109, when pressurized (providing pressurized fluid in a direction in accordance with arrow a), and is arranged around the rod arrangement 109 for alternately engagement to the rod arrangement 109. By pressurizing a first cylinder chamber 121 (providing pressurized fluid in a direction in accordance with arrow b), the piston body 107 and the rod arrangement 109 is moved from the first position P1 to the second position P2 providing a first step. The driving actuator 115 further comprises a second engagement and disengagement device 125 arranged for alternately engagement to rod arrangement 109.

The first position P1 is defined as a starting point of the piston body 107 in the cylinder body (in this embodiment) facing away from the second engagement and disengagement device 125 and the second position P2 is defined as an end position of the cylinder piston body 107 in the cylinder body 105 facing the second engagement and disengagement device 125.

The first engagement and disengagement device 119 respective the second engagement and disengagement device 125 are configured for alternately and/or simultaneously engagement to the rod arrangement 109. The first engagement and disengagement device 119 provides a motion of the aircraft secondary control member 111 incrementally in steps and the second engagement and disengagement device 125 provides locking of the aircraft secondary control member 111 relative the aircraft wing 112.

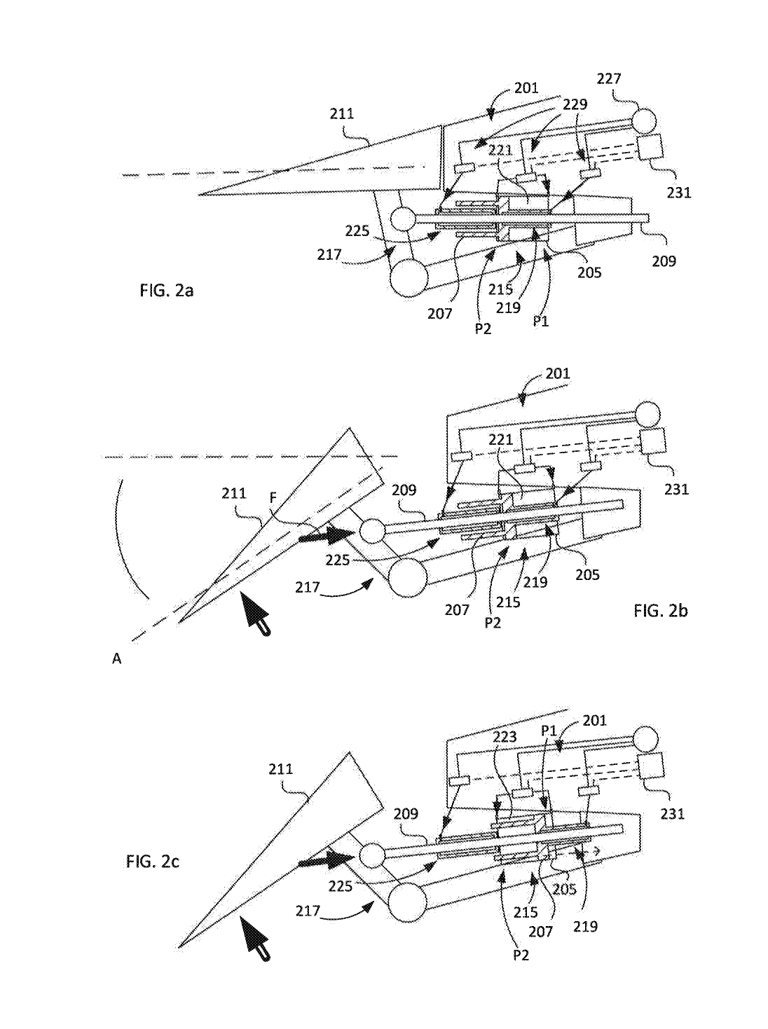

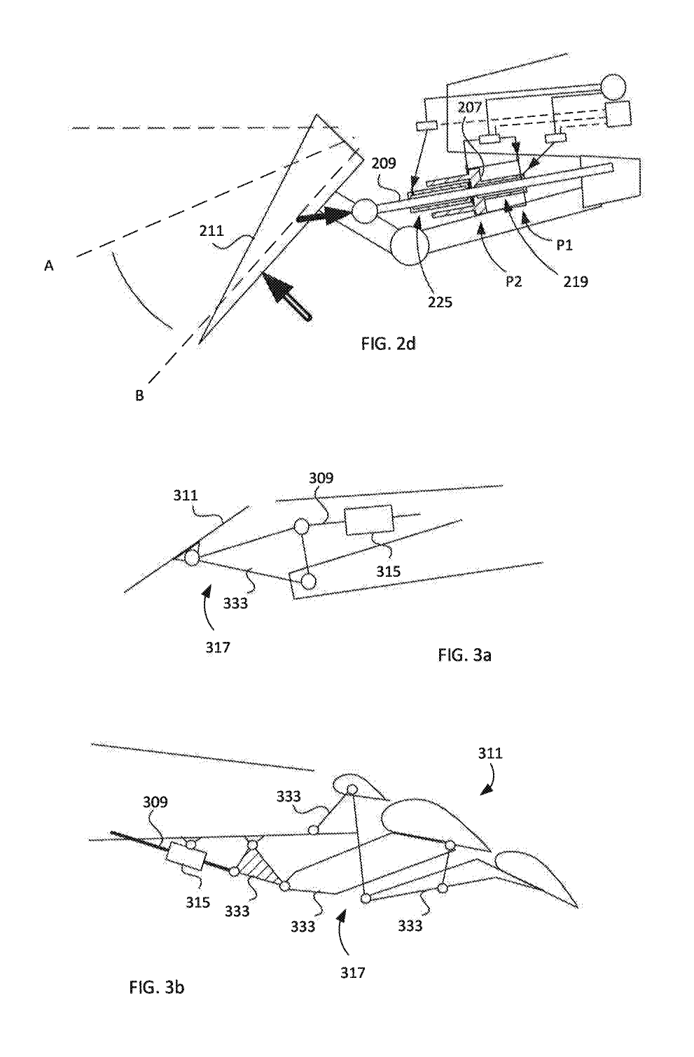

FIGS. 2a to 2d illustrate an aircraft secondary control system 201 according to a second example of the present invention. The aircraft secondary control system 201 is configured to move the aircraft secondary control member 211 a first and a second extraction step A and B (see FIG. 2d). The first extraction step may be defined as a first angular displacement of the aircraft secondary control member 211 relative the wing and the second extraction step may be defined as a second angular displacement of the aircraft secondary control member 211 relative the wing.

FIG. 2a illustrates a rod arrangement 209 being coupled to the aircraft secondary control member 211 via a linkage arrangement 217. A driving actuator 215 comprises a first engagement and disengagement device 219 of a piston body 207 and a second engagement and disengagement device 225, each of which being configured for alternately and/or simultaneously engaging said rod arrangement 209. The piston body 207 is arranged in a cylinder body 205 and is configured to make a working stroke from a first position P1 to a second position P2.

A fluid supply 227 is coupled via a valve arrangement 229 to the cylinder body 205 and to the first engagement and disengagement device 219 and to the second engagement and disengagement device 225. A control unit 231 is coupled to the valve arrangement 229 and to a sensor device (not shown) for detecting the position of the aircraft secondary control member 211. The control unit 231 is configured for controlling the actuating of the driving actuator 215 from operating commands and from detected sensor signals generated by the sensor device. The linkage arrangement 217 is configured move the aircraft secondary control member 211 a first extraction step by said working stroke. For extraction of the aircraft secondary control member 211, the control unit 231 controls the pressurization of and engage the second engagement and disengagement device 225 to the rod arrangement 209 for holding it and controls the piston body 207 to make a retraction stroke back to the first position P1 from the second position P2, while the first engagement and disengagement device 219 is disengaged. Subsequently, in the first position P1, the first engagement and disengagement device 219 is controlled to be engaged to the rod arrangement 209 and the first cylinder chamber 221 is pressurized. The second engagement and disengagement device 225 is disengaged and the aircraft secondary control member 211 is free to make the first extraction step A.

In FIG. 2b is shown that the second engagement and disengagement device 225 is pressurized when the piston body 207 reached the second position P2. The first engagement and disengagement device 219 of the piston body 207 and the first cylinder chamber 221 are also pressurized for holding the aircraft secondary control member 211 in the first extraction step A as shown in FIG. 2b. Drag forces will generate a force F on the rod arrangement 209.

In FIG. 2c is shown that the second engagement and disengagement device 225 is pressurized for holding the rod arrangement 209 meantime the first engagement and disengagement device 219 is disengaged and a second cylinder chamber 223 of the cylinder body 205 is pressurized for retracting the piston body 207 from the second position P2 to the first position P1. In FIG. 2d is shown that the second engagement and disengagement device 225 is pressurized after moving the piston body 207 together with the rod arrangement 209 a distance corresponding with said working stroke from the first position P1 to the second position P2. In such way is achieved a well-defined extraction motion step from step A to step B of the aircraft secondary control member 211, by controlling the piston body 207, being in engagement with the rod arrangement 209, to perform a distinct working stroke between the first P1 and second position P2.

FIGS. 3a to 3b illustrate an aircraft secondary control system according to a third and fourth example of the present disclosure. FIG. 3a shows a rod arrangement 309 of a driving actuator 315, configured for performing the motion of a trailing edge flap 311 incrementally in steps. The rod arrangement 309 is coupled to the trailing edge flap 311 via a linkage arrangement 317 comprising a crank member 333. The driving actuator 315 comprises a first engagement and disengagement device of a piston body (not shown) and a second engagement and disengagement device (not shown), each of which being configured for alternately and/or simultaneously engaging the rod arrangement 309. The piston body is arranged in a cylinder body (not shown) and is configured to make a working stroke from a first position to a second position. FIG. 3b shows a rod arrangement 309 of a driving actuator 315, configured for performing the motion of a trailing edge flap arrangement 311 incrementally in steps. The rod arrangement 309 is coupled to the trailing edge flap arrangement 311 via a linkage arrangement 317 comprising a set of crank members 333 and linkage arms 335. The driving actuator 315 comprises a first engagement and disengagement device of a piston body (not shown) and a second engagement and disengagement device (not shown), each of which being configured for alternately and/or simultaneously engaging the rod arrangement 309. The piston body is arranged in a cylinder body (not shown) and is configured to make a working stroke from a first position to a second position.

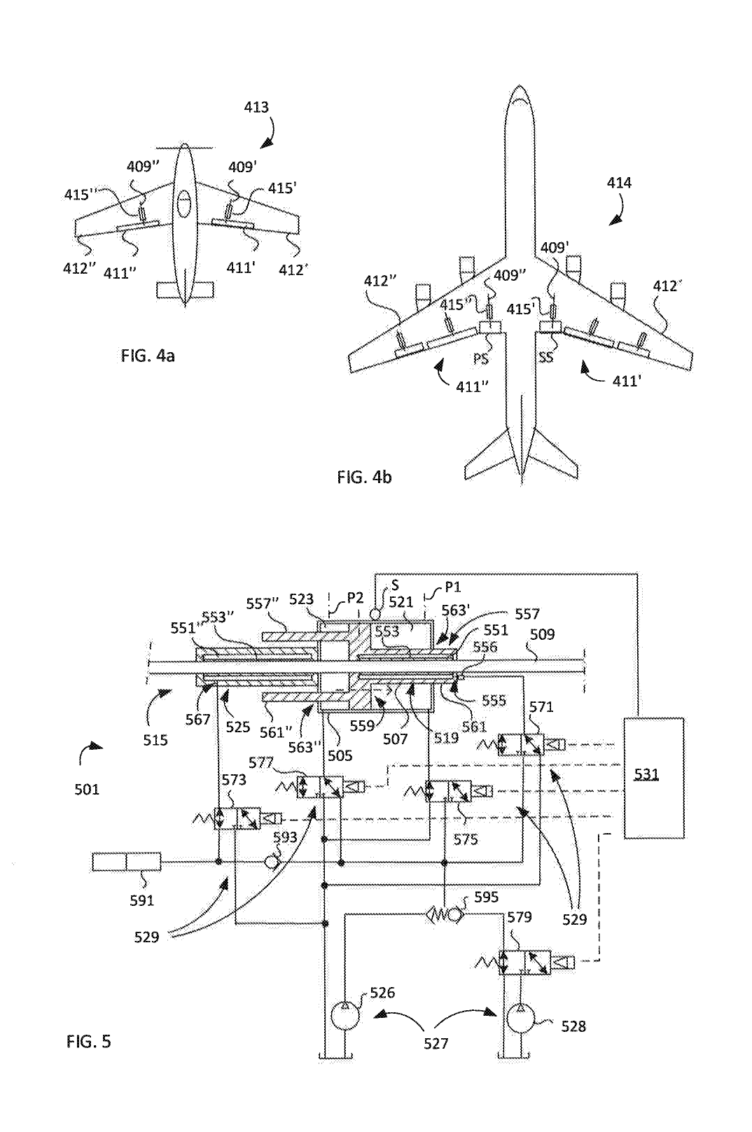

FIGS. 4a to 4b illustrate two types of aircraft using the aircraft secondary control system according to further examples of the present disclosure. FIG. 4a illustrates a light aircraft 413 for general aviation comprising a right flap 411′ at right wing 412′ and a left flap 411″ at left wing 412″. The right flap 411′ is coupled to a first rod arrangement 409′ of a first driving actuator 415′, configured for performing the motion of the right flap 411′ incrementally in steps. The first rod arrangement 409′ is coupled to the right flap 411′ via a first linkage arrangement (not shown). The left flap 411″ is coupled to a second rod arrangement 409″ of a second driving actuator 415″, configured for performing the motion the left flap 411″ incrementally in steps. The second rod arrangement 409″ is coupled to the left flap 411″ via a second linkage arrangement (not shown). A control unit (not shown) controls the first and second driving actuators 415′, 415″ to instantly pressurizing second right and left engagement and disengagement devices (i.e. second engagement and disengagement devices) at the same time (not shown). In such way the flaps of right and left wing 412′, 412″ can be locked in case of discrepancy in extraction or retraction of the flaps. FIG. 4b illustrates a commercial aircraft 414 comprising a right flap arrangement 411′ at right wing 412′ and a left flap arrangement 411″ at left wing 412″. The right flap arrangement 411′ comprises a right flap section SS that is coupled to a first rod arrangement 409′ of a first driving actuator 415′, configured for performing the motion of the right flap section SS incrementally in steps. The first rod arrangement 409′ is coupled to the right flap section SS of the right flap arrangement 411′ via a first linkage arrangement (not shown). The left flap arrangement 411″ comprises a left flap section PS that is coupled to a second rod arrangement 409″ of a second driving actuator 415″, configured for performing the motion of the left flap section PS incrementally in steps. The second rod arrangement 409″ is coupled to the left flap section PS of the left flap arrangement 411″ via a second linkage arrangement (not shown). Preferably, the other flap sections of the wing are coupled to driving actuators in a similar way. A control unit (not shown) controls the first and second driving actuators 415′, 415″ to instantly pressurizing second right and left engagement and disengagement devices (not shown) at the same time. In such way the flap arrangements 411′, 411″ of right and left wing 412′, 412″ can be locked in case of discrepancy in extraction or retraction between the right flap arrangement 411′ and the left flap arrangement 411″.

FIG. 5 illustrates an aircraft secondary control system 501 according to a fifth example of the present invention. The aircraft secondary control system 501 is configured to provide a motion of an aircraft secondary control member (not shown) incrementally in steps and comprises a rod arrangement 509 of a driving actuator 515, configured for performing the motion. The rod arrangement 509 is coupled to the aircraft secondary control member via a crank member (constituting a linkage arrangement) (not shown). The driving actuator 515 comprises a first engagement and disengagement device 519 of a piston body 507 and comprises a second engagement and disengagement device 525, each of which being configured for alternately and/or simultaneously engaging the rod arrangement 509. The piston body 507 is arranged in a cylinder body 505 and is configured to make a working stroke from a first position P1 to a second position P2. The rod arrangement 509 is configured move the aircraft secondary control member a first extraction step by the working stroke.

A fluid supply 527 is coupled via a valve arrangement 529 to the cylinder body 505 and to the respective first 519 and second 525 engagement and disengagement device. The first engagement and disengagement device 519 comprises a first expandable space 551 forming a first expandable wall portion 553 arranged adjacent the rod arrangement 509 and is arranged co-axial with the rod arrangement 509. The first expandable wall portion 553 is arranged to be expandable inward toward the rod arrangement 509 for engagement of the piston body 507 to the rod arrangement 509 and is configured for fluid communication with the fluid supply 527 via a first channel system 555 of the piston body 507. The first channel system 555 exhibits a first opening facing the first expandable space and exhibits a second opening configured to be in fluid communication with the fluid supply 527 and configured to be coupled to a first coupling member 556 positioned exterior a first and second cylinder chamber 521, 523 (i.e. exterior the cylinder body 505).

Furthermore, the piston body 507 comprises a first axially protruding sleeve portion 557 protruding from a radially protruding portion 559, which first axially protruding sleeve portion 557 exposes a first sleeve portion envelope surface 561 (exterior the cylinder body 507) during the working stroke. The piston body 507 comprises a second axially protruding sleeve portion 557″ protruding from the radially protruding portion 559, which second axially protruding sleeve portion 557″ exposes a second sleeve portion envelope surface 561″ (exterior the cylinder body 507) during the working stroke. The first coupling member 556 is arranged at the first sleeve portion (e.g. at its end or at envelope surface 561). The first axially protruding sleeve portion 557 extends through a first opening 563′ of a first end cap of the cylinder body 505.

The second axially protruding sleeve portion 557″ extends through a second opening 563″ of a second end cap of the cylinder body 505. The second engagement and disengagement device 525 constitutes a static holding unit comprising a second expandable wall portion 553″ of a second expandable space 551″ arranged adjacent the rod arrangement 509. The second expandable wall portion 553″ is arranged to be expandable inward toward the rod arrangement 509 for engagement of the second engagement and disengagement device 525 to the rod arrangement 509 and is configured for fluid communication with the fluid supply 527 via a second channel system 567 of the second engagement and disengagement device 525. A first solenoid on/off valve 571 is coupled to the first engagement and disengagement device 519 of the piston body 507 is configured in deactivated state to provide an open fluid passage between the fluid supply 527 and the first expandable space 551 of the first engagement and disengagement device 519. A second solenoid on/off valve 573 is coupled to the second engagement and disengagement device 525 and is configured in deactivated state to provide an open fluid passage between the fluid supply 527 and the second expandable space 551″ of the second engagement and disengagement device 525. A third solenoid on/off valve 575 is coupled to the first cylinder chamber 521 and to the fluid supply 527. A fourth solenoid on/off valve 577 is coupled to the second cylinder chamber 523 and to the fluid supply 527. Preferably, any kind of valve arrangement and/or the first valve member and/or the second valve member may comprise solenoid on/off valve or other controlling functionality configured for controlling the flow of fluid to the respective first and second cylinder chamber 521, 523. A control unit 531 is coupled to the valve arrangement and to a sensor device S of the driving actuator.

In this embodiment, the aircraft secondary control system 501 is designed for redundancy (dual modular redundancy DMR) by a second fluid 528 separately operated. A fifth solenoid on/off valve 579 is activated by the control unit 531 in case of critical function and failure in main fluid supply 526. Of course, the system may be designed for triple modular redundancy as well. An accumulator 591 is coupled to the second expandable space 551″ of the second engagement and disengagement device 525 via the second solenoid on/off valve 573. Furthermore, a first non-return valve 593 is arranged between the accumulator 591 and the fluid supply 527. The accumulator 591 provides that the aircraft secondary control system 501 will cope with certain demands, such as power cut or variations in fluid temperature. A second non-return valve 595 is arranged between the fifth solenoid on/off valve 579 and the main fluid supply 526.

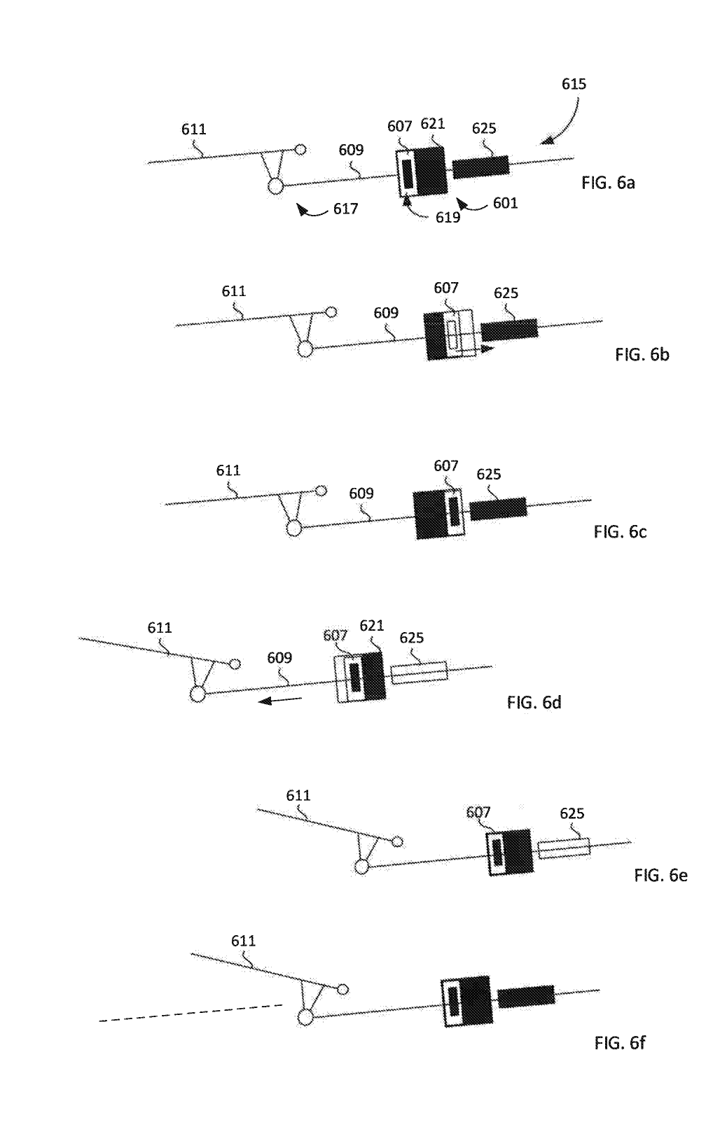

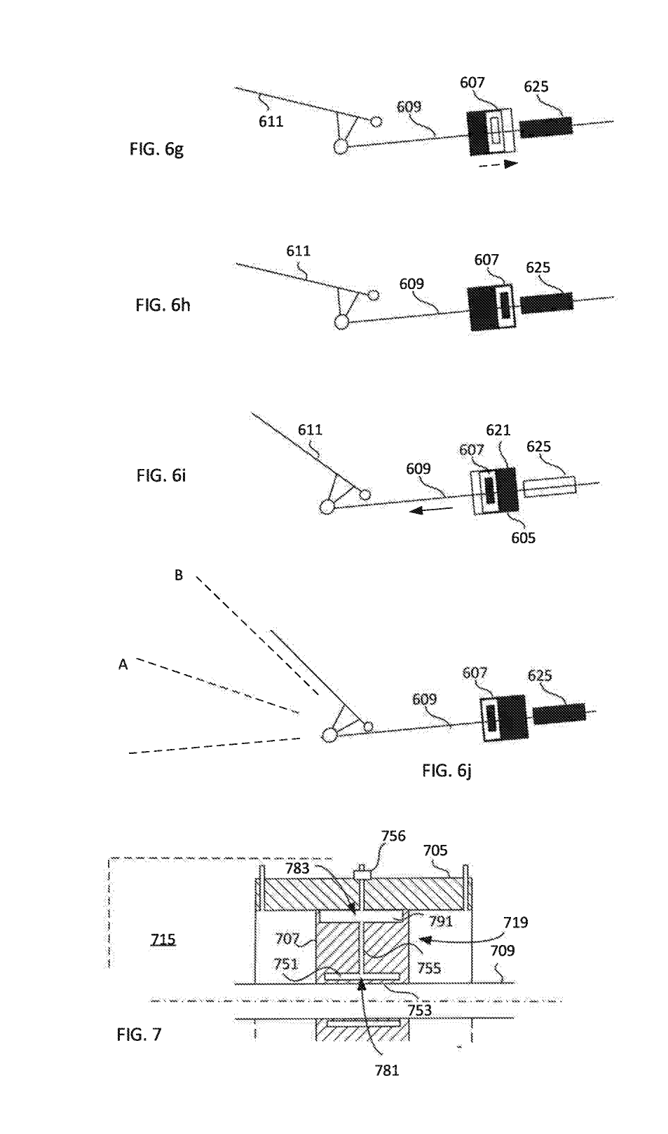

FIGS. 6a to 6j illustrate an aircraft secondary control system 601 according to a sixth example of the present invention. Filled areas with black schematically illustrate pressurized devices and non-filled areas of said devices schematically illustrate non-pressurized states or states where the pressure is lower. The system 601 is configured to move an aircraft secondary control member 611 incrementally in steps in predetermined deflection rates. FIG. 6a shows that a second engagement and disengagement device 625 of a driving actuator 615 is controlled to be engaged with a linkage rod 609 for moving the aircraft secondary control member 611 via a linkage arrangement 117. A piston body 607 is controlled to be engaged to the linkage rod 609 by means of a first engagement and disengagement device 619. A first cylinder chamber 621 is pressurized for secure locking the aircraft secondary control member 611. FIG. 6b shows that the piston body being retracted to a starting position, wherein the piston body 607 is disengaged from the linkage rod 609. The linkage rod 609 is held in position by the engagement of the second engagement and disengagement device 625 to the linkage rod 609. FIG. 6c shows a start position followed by the extraction of the air brake 611 (FIG. 6d), whereby the second engagement and disengagement device 625 is disengaged from the linkage rod 609 and the piston body 607 is engaged with the linkage rod 609 for moving the aircraft secondary control member 611 by the pressurization of the first cylinder chamber 621 together with the linkage rod 609 a distance corresponding with the stroke length of the cylinder body interior length. FIG. 6e shows that the piston body 607 has reached the second position after making a full length working stroke whereby the aircraft secondary control member 611 has moved a first discrete step according to a predetermined deflection rate. In FIG. 6f is shown that the also the second engagement and disengagement device 625 is engaged to the linkage rod 609 for secure locking of the aircraft secondary control member 611 in said first step. For moving the aircraft secondary control member 611 to a second step, the procedure is repeated as shown in FIG. 6g wherein the second engagement and disengagement device 625 holds the linkage rod 609 and the piston body 607 is retracted to a first starting position as shown in FIG. 6h. In FIG. 6i is shown the extraction of the air brake 611 toward a step B (see FIG. 6j), whereby the second engagement and disengagement device 625 is disengaged from the linkage rod 609 and the piston body 607 is engaged with the linkage rod 609 for moving the aircraft secondary control member 611 by the pressurization of the first cylinder chamber 621 together with the linkage rod 609 a distance corresponding with the stroke length of the cylinder body 605 interior length. FIG. 6j shows that the piston body 607 has reached the second position after making a full length working stroke whereby the aircraft secondary control member 611 has been moved to a second discrete step B according to a predetermined deflection rate.

FIG. 7 illustrates a portion of a driving actuator 715 according to a seventh example of the present invention. The driving actuator comprises piston body 707 arranged in a cylinder body 705. The piston body comprises a first engagement and disengagement device 719 comprising a first expandable space 751. A first channel system 755 exhibits a first opening 781 facing the first expandable space and exhibits a second opening 783 configured to be in fluid communication with a fluid supply (not shown). The fluid supply is configured to be coupled to a coupling member 756 positioned exterior a first and second cylinder chamber of the cylinder body 705 (partly or entirely exterior the cylinder body 705 wall). The first expandable space 751 forms an expandable wall portion 753 arranged to be expandable inward toward the rod arrangement 709 for engagement of the piston body 707 to the rod arrangement 709 and is configured for fluid communication with the fluid supply via a first channel system 755. An elongated cavity 791 is provided in the piston body 707 envelope surface facing the cylinder wall (and/or arranged in the cylinder wall), which elongated cavity 791 is configured to provide fluid communication between the fluid supply and the first expandable space 751 during the reciprocating stroke motion of the piston body 707 in the cylinder body 705.

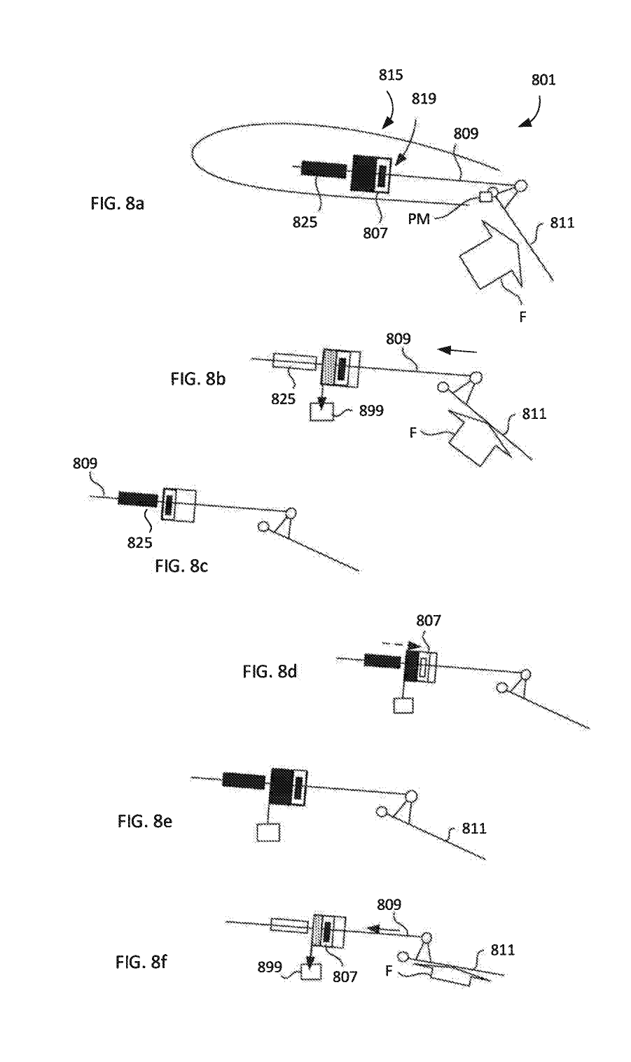

FIGS. 8a to 8f illustrate an aircraft secondary control system 801 according to an eight example of the present invention. Filled areas with black schematically illustrate pressurized devices and non-filled areas of said devices schematically illustrate non-pressurized states or states where the pressure is lower. FIG. 8a illustrates a trailing edge flap (as an example) 811 of the aircraft secondary control system 801 that is in extended position during flight. A force F generated by the airflow passing the wing will urge the trailing edge flap 811 upward. A driving actuator 815 locks the trailing edge flap 811 in position. For retraction of the trailing edge flap 811 in steps, a first engagement and disengagement device 819 of a piston body 807 is controlled to engage a piston rod 809, which is coupled to the trailing edge flap 811. An angular potentiometer PM (sensor) is arranged to the flap 811 for detection of present angular deflection state of the flap relative the wing and is coupled to the control unit (not shown). A second engagement and disengagement device 825 is disengaged from the piston rod 809 as being shown in FIG. 8b. As the force F urges the trailing edge flap 811 upward, and the piston body 807 being engaged with the piston rod 809, the piston body 807 will make a retraction stroke in correspondence with a retraction step of the trailing edge flap 811. A throttling device 899 is configured for providing a restriction of the retraction rate for providing a soft retraction of the trailing edge flap 811. FIG. 8c shows the engagement of the second engagement and disengagement device 825 to the piston rod 809 for locking action. FIG. 8d shows the retraction of the piston body 807 to a starting position. FIG. 8e shows the start position for retraction of the trailing edge flap 811 a further retraction step. The first engagement and disengagement device 819 is controlled to engage the piston rod 809. The second engagement and disengagement device 825 is disengaged from the piston rod 809 in FIG. 8f. As the force F urges the trailing edge flap 811 upward, and the piston body 807 being engaged with the piston rod 809, the piston body 807 will make a retraction (working) stroke in correspondence with a retraction step of the trailing edge flap 811. The throttling device 899 will provide a restriction of the retraction rate.

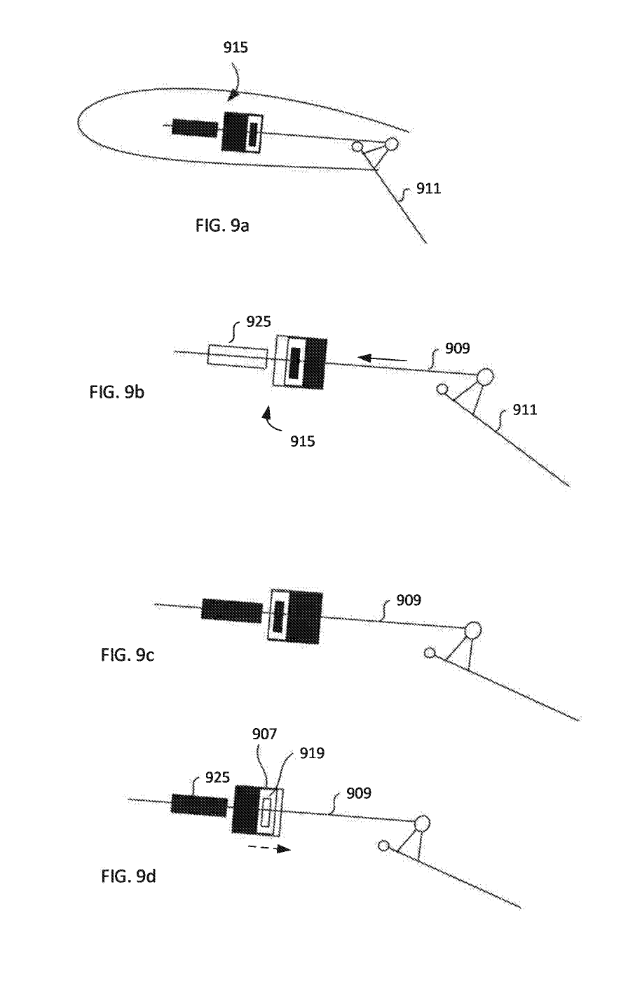

FIGS. 9a to 9d illustrate an aircraft secondary control system according to a ninth example of the present invention. Filled areas with black schematically illustrate pressurized devices and non-filled areas of said devices schematically illustrate non-pressurized states or states where the pressure is lower. Retraction of a trailing edge flap 911 is made by means of a driving actuator 915. The aircraft is positioned on the ground which means that the gravity urges the trailing edge flap 911 downward.

FIG. 9a shows the trailing edge flap 911 in locked position. FIG. 9b shows how the driving actuator 815 moves the trailing edge flap 911 in a retraction step, a second engagement and disengagement device 925 is disengaged from the piston rod 909. FIG. 9c shows the fulfilled retraction step and the locking of the piston rod 909. FIG. 9d shows that locking of the piston rod 909 is maintained by means of the second engagement and disengagement device 925 and a first engagement and disengagement device 919 is disengaged from the piston rod 909 for performance of a retraction stroke of the piston body 907 to a starting position, from which starting position, the trailing edge flap 911 can be retracted a further retraction step by repeating the procedure.

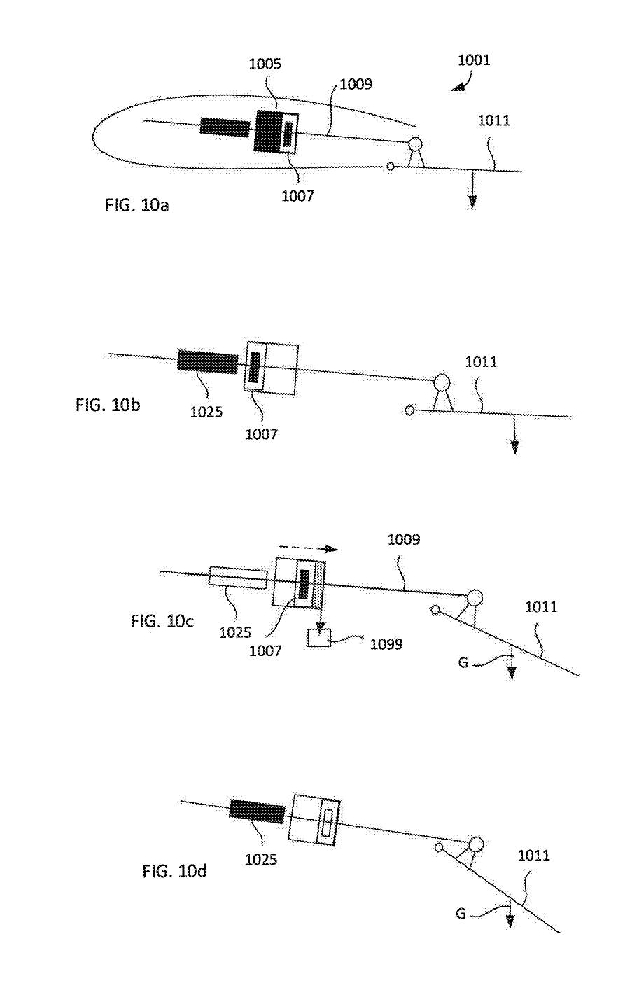

FIGS. 10a to 10d illustrate an aircraft secondary control system 1001 according to a tenth example of the present invention. Filled areas with black schematically illustrate pressurized devices and non-filled areas of said devices schematically illustrate non-pressurized states or states where the pressure is lower than black areas. When the aircraft is positioned on ground and a trailing edge flap 1011 is to be extracted in steps by means of a piston rod 1009 of the system 1001, the system 1001 may use the gravity force G for extraction of the trailing edge flap 1011. A piston body 1007 of a cylinder body 1005 is moved to a starting point as shown in FIG. 10b, wherein a second engagement and disengagement device 1025 holds the trailing edge flap 1011 in position. FIG. 10c shows that the piston body 1007 is engaged with the piston rod 1009 and the gravity acts on the trailing edge flap 1011 and the piston rod 1009. The second engagement and disengagement device 1025 is disengaged from the piston rod 1009. As the gravity urges the trailing edge flap 1011 downward, and the piston body 1007 being engaged with the piston rod 1009, the piston body 1007 will make a retraction (working) stroke in correspondence with a retraction step of the trailing edge flap 1011. A throttling device 1099 is coupled to a first cylinder chamber of the cylinder body 1005 and will provide a restriction of the retraction rate. FIG. 10d shows a fulfilled retraction step of the trailing edge flap 1011 being locked in a first retraction step position by the second engagement and disengagement device 1025.

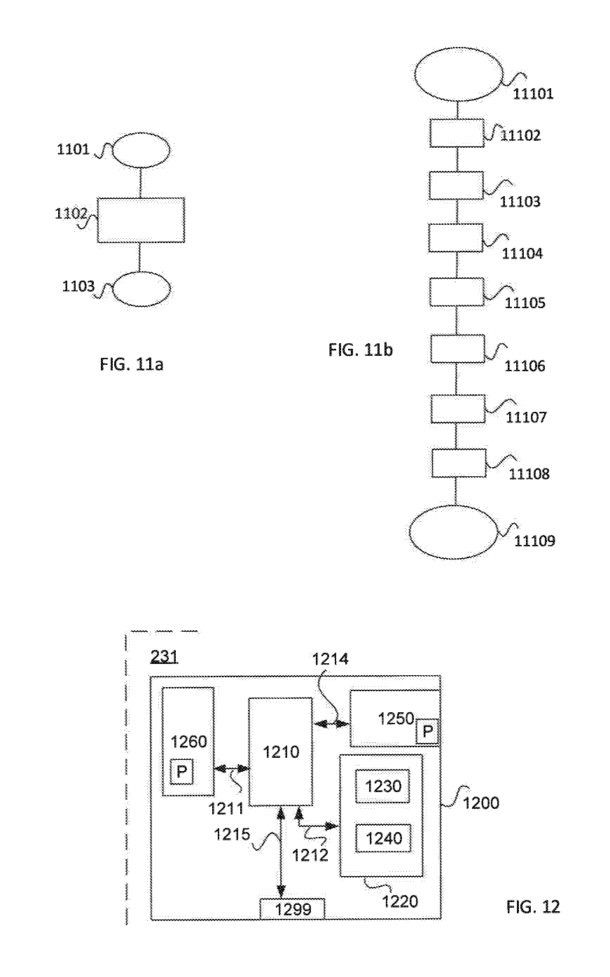

FIGS. 11a-11b illustrate flowcharts showing exemplary methods for providing a motion of an aircraft secondary control member incrementally in steps according to different aspects. FIG. 11a illustrates a method for providing a motion of an aircraft secondary control member of an aircraft secondary control system incrementally in steps. The aircraft secondary control system comprises a rod arrangement of a driving actuator, configured for performing the motion, the rod arrangement being coupled to the aircraft secondary control member (e.g. via a linkage arrangement). The driving actuator comprises a first engagement and disengagement device of a piston body and comprises a second engagement and disengagement device, each of which being configured for alternately and/or simultaneously engaging said rod arrangement. The piston body is arranged in a cylinder body and is configured to make a working stroke from a first position to a second position.

The method shown in FIG. 11a illustrates a first step 1101 comprising the start of the method. A second step 1102 illustrates a method for providing the motion of the aircraft secondary control member incrementally in steps. A third step 1101 illustrates a stop of the method. The second step 1102 may comprise the steps of; engaging the piston body to the rod arrangement; moving the piston body together with the rod arrangement a distance corresponding with said working stroke; engaging the second engagement and disengagement device to the rod arrangement; disengaging the first engagement and disengagement device from the rod arrangement; retracting the piston body from the second position to the first position; repeating the previous method steps for providing said motion.

FIG. 11b illustrates a further example of the method. Step 11101 illustrates start of the method. Step 11102 shows engaging the piston body to the rod arrangement. Step 11103 shows disengaging the second engagement and disengagement device from the rod arrangement. Step 11104 shows moving the piston body together with the rod arrangement a distance corresponding with said working stroke. Step 11105 comprises that a first extraction step or a first retraction step of said motion is performed in correspondence with a first movement of the piston body travelling along the length of the working stroke. Step 11106 comprises that a second extraction step or a second retraction step of said motion is made in correspondence with a second movement of the piston body travelling along the length of the working stroke. Step 11107 comprises that the working stroke is a full length working stroke made by the piston body within the cylinder body interior. Step 11108 comprises that the linkage arrangement is configured to provide a first extraction step or first retraction step corresponding with 5 degrees or 8, 11 or 14 degrees or any other value of each step. In Step 11109 the method is fulfilled and stopped.

FIG. 12 illustrates a CPU device 1200 according to different embodiments of the disclosure. The CPU device 1200 may be formed in a control unit 231 of an aircraft secondary control system. The control unit 231 is configured for providing a motion of an aircraft secondary control member incrementally in steps is marked with the reference sign 231. The control unit comprises the CPU device 1200 of a computer. The CPU device 1200 comprises a non-volatile memory NVM 1220, which is a computer memory that can retain stored information even when the computer is not powered. The CPU device 1200 further comprises a processing unit 1210 and a read/write memory 1250. The NVM 1220 comprises a first memory unit 1230. A computer program (which can be of any type suitable for any operational data) is stored in the first memory unit 1230 for controlling the functionality of the CPU device 1200. Furthermore, the CPU device 1200 comprises a bus controller (not shown), a serial communication left (not shown) providing a physical interface, through which information transfers separately in two directions. The CPU device 1200 may comprise any suitable type of I/O module (not shown) providing input/output signal transfer, an A/D converter (not shown) for converting continuously varying signals from detectors (not shown) of the aircraft secondary control system and from other monitoring units (not shown), positioned within the aircraft secondary control system in suitable positions, into binary code suitable for the computer.

The CPU device 1200 also comprises an input/output unit (not shown) for adaption to time and date. The CPU device 1200 also comprises an event counter (not shown) for counting the number of event multiples that occur from independent events in operation of the fluid actuator arrangement. Furthermore, the CPU device 1200 includes interrupt units (not shown) associated with the computer for providing a multi-tasking performance and real time computing for operating a first and second mode of operation as described above. The NVM 1220 also includes a second memory unit 1240 for external controlled operation.

A data medium storing program P, comprising program routines, is adapted for controlling the valve arrangement and extraction/retraction step motions of the aircraft secondary control member and is provided for operating the CPU device 1200 for performing the method described. The data medium storing program P may comprise routines for providing a step-wise extraction/retraction of the aircraft secondary control member in an automatic or semi-automatic way. The data medium storing program P comprises a program code stored on a medium, which is readable on the computer, for causing the control unit (e.g. the control unit marked with reference number 321) to perform a method for providing a motion of an aircraft secondary control member of an aircraft secondary control system incrementally in steps. The aircraft secondary control system comprises a rod arrangement of a driving actuator, configured for performing the motion, is coupled to the aircraft secondary control member (e.g. via a linkage arrangement); the driving actuator comprises a first engagement and disengagement device of a piston body and comprises a second engagement and disengagement device, each of which being configured for alternately and/or simultaneously engaging said rod arrangement; the piston body is arranged in a cylinder body and is configured to make a working stroke from a first position to a second position; wherein the method comprises the steps of; engaging the piston body to the rod arrangement; moving the piston body together with the rod arrangement a distance corresponding with said working stroke; engaging the second engagement and disengagement device to the rod arrangement; disengaging the first engagement and disengagement device from the rod arrangement; retracting the piston body from the second position to the first position; repeating the previous method steps for providing said motion.

The data medium storing program P further may be stored in a separate memory 1260 and/or in the read/write memory 1250. The data medium storing program P, in this embodiment, is stored in executable or compressed data format.

It is to be understood that when the processing unit 1210 is described to execute a specific function that involves that the processing unit 1210 may execute a certain part of the program stored in the separate memory 1260 or a certain part of the program stored in the read/write memory 1250.

The processing unit 1210 is associated with a data left 1299 for communication via a first data bus 1215. The non-volatile memory NVM 1220 is adapted for communication with the processing unit 1210 via a second data bus 1212. The separate memory 1260 is adapted for communication with the processing unit 1210 via a third data bus 1211. The read/write memory 1250 is adapted to communicate with the processing unit 1210 via a fourth data bus 1214. The data left 1299 is preferably connectable to data links of the aircraft secondary control system. When data is received by the data left 1299, the data will be stored temporary in the second memory unit 1240. After that the received data is temporary stored, the processing unit 1210 will be ready to execute the program code, according to the above-mentioned procedure. Preferably, the signals (received by the data left 1299) comprise information about operational status of the fluid actuator arrangement, such as operational status regarding the position of the aircraft secondary control member, the position of the rod arrangement, the position of the piston body relative the cylinder body. The signals may also comprise information about e.g. operational data regarding the position of the aircraft secondary control member and extraction/retraction performance.

According to one aspect, signals received by the data left 1299 may contain information about actual positions of the aircraft secondary control member by means of sensor members. The received signals at the data left 1299 can be used by the CPU device 1200 for controlling and monitoring of the raising and lowering of the aircraft secondary control member in a cost-effective way. The signals received by the data left 1299 can be used for automatically moving the aircraft secondary control member between two end positions. The signals can be used for different operations of the fluid actuator arrangement. The information is preferably measured by means of suitable sensor members of the fluid actuator arrangement. The information can also be manually fed to the control unit via a suitable communication device, such as a computer display.

The method can also partially be executed by the CPU device 1200 by means of the processing unit 1210, which processing unit 1210 runs the data medium storing program P being stored in the separate memory 1260 or the read/write memory 1250. When the CPU device 1200 runs the data medium storing program P, suitable method steps disclosed herein will be executed. A data medium storing program product comprising a program code stored on a medium is also provided, which product is readable on the computer, for performing method steps providing a motion of an aircraft secondary control member incrementally in steps, when the data medium storing program P according to claim 14 is run on the control unit.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims.

The valve arrangement may comprise an on/off valve of suitable type or other valves. The valve arrangement may comprise directional control valves or others, or may comprise a two-way valve of any type suitable for controlling the aircraft secondary control system. The manoeuvring of the valve arrangement may be performed by means of a solenoid connected to the control unit adapted for controlling the valve arrangement for extracting and retracting an aircraft secondary control member incremental in steps, each step corresponds with a working stroke of a distinct length determined by the internal length of the cylinder body.

1. A method for providing a motion of an aircraft secondary control member incrementally in steps;
wherein a rod arrangement of a driving actuator is configured for performing the motion and is coupled to the aircraft secondary control member;
wherein the driving actuator comprises a first engagement and disengagement device of a piston body and comprises a second engagement and disengagement device, each of which being configured for alternately and/or simultaneously engaging said rod arrangement;
wherein the piston body is arranged in a cylinder body and is configured to perform a working stroke from a first position to a second position;
the method comprises the steps of:
engaging the first engagement and disengagement device of the piston body to the rod arrangement;
controlling the piston body to perform the working stroke to move the rod arrangement a distance corresponding with said working stroke;
engaging the second engagement and disengagement device to the rod arrangement;
disengaging the first engagement and disengagement device from the rod arrangement; and
retracting the piston body from the second position to the first position; wherein
a first extraction step or a first retraction step of said motion is performed in correspondence with a first movement of the piston body travelling along the length of the working stroke.

2. The method according to claim 1, wherein the step of retracting the piston body from the second position to the first position is followed by the steps of:
engaging the first engagement and disengagement device of the piston body to the rod arrangement;
disengaging the second engagement and disengagement device from the rod arrangement;
moving the piston body together with the rod arrangement a distance corresponding with said working stroke.

3. The method according to claim 1, wherein a fluid supply is coupled via a valve arrangement to the cylinder body and to the first and second engagement and disengagement device and the valve arrangement comprises on/off valves.

4. The method according to claim 3, wherein a second extraction step or a second retraction step of said motion is performed in correspondence with a second movement of the piston body travelling along the length of the working stroke.

5. The method according to claim 1, wherein the working stroke is a full length working stroke made by the piston body within the cylinder body interior.

6. The method according to claim 1, wherein a linkage arrangement is configured to provide a first extraction step or a first retraction step corresponding with 5 degrees.

7. An aircraft secondary control system for providing a motion of an aircraft secondary control member incrementally in steps, the system comprises:
a rod arrangement of a driving actuator, configured for performing the motion, is coupled to the aircraft secondary control member;
the driving actuator comprises a first engagement and disengagement device of a piston body and comprises a second engagement and disengagement device, each of which being configured for alternately and/or simultaneously engaging said rod arrangement;
the piston body is arranged in a cylinder body and is configured to make a working stroke from a first position to a second position; wherein
a first extraction step or a first retraction step of said motion is performed in correspondence with a first movement of the piston body travelling along the length of the working stroke.

8. The aircraft secondary control system according to claim 7, wherein a linkage arrangement is configured move the aircraft secondary control member a first extraction step by said working stroke.

9. The aircraft secondary control system according to claim 7, wherein a fluid supply is coupled via a valve arrangement to the cylinder body and to the first and second engagement and disengagement device.

10. The aircraft secondary control system according to claim 7, wherein the first engagement and disengagement device comprises a first expandable space.

11. The aircraft secondary control system according to claim 7, wherein the second engagement and disengagement device comprises a second expandable space.

12. The aircraft secondary control system according to claim 7, wherein a control unit is coupled to the valve arrangement and to a sensor device of the driving actuator.

13. The aircraft secondary control system according to claim 7, wherein an accumulator is coupled to a second expandable space of the second engagement and disengagement device via a valve arrangement.

14. The aircraft secondary control system according to claim 7, wherein a non-return valve is arranged between the accumulator and the fluid supply.

15. An aircraft comprising an aircraft secondary control system for providing a motion of an aircraft secondary control member incrementally in steps, the aircraft secondary control system comprises:
a rod arrangement of a driving actuator, configured for performing the motion, is coupled to the aircraft secondary control member;
the driving actuator comprises a first engagement and disengagement device of a piston body and comprises a second engagement and disengagement device, each of which being configured for alternately and/or simultaneously engaging said rod arrangement;
the piston body is arranged in a cylinder body and is configured to make a working stroke from a first position to a second position; wherein the driving actuator is configured for moving the aircraft secondary control member by performing the method steps according to claim 1.

16. A data medium storing program adapted for moving an aircraft secondary control member of an aircraft according to claim 15, wherein said data medium storing program comprises a program code stored on a medium, which is readable on a computer, for causing a control unit to perform the method steps of:
engaging the piston body to the rod arrangement;
moving the piston body together with the rod arrangement a distance corresponding with said working stroke;
engaging the second engagement and disengagement device to the rod arrangement;
disengaging the first engagement and disengagement device from the rod arrangement; and
retracting the piston body from the second position to the first position.

17. A data medium storing program product comprising a program code stored on a medium, which is readable on a computer, for performing the method steps according to claim 1, when a data medium storing program according to claim 16 is run on a control unit.
